(19) United States
(12) Patent Application Publication
(10) Pub. No.: US 2023/0078484 A1
(43) Pub. Date: Mar. 16, 2023

(54) SYSTEM AND METHOD FOR IMPLEMENTING IN-FLIGHT CHANGES TO A WORKFLOW

(71) Applicant: ServiceNow, Inc., Santa Clara, CA (US)

(72) Inventors: Jason Michael Occhialini, Loomis, CA (US); Sarath Ambati, Union City, CA (US); Shilpa Janagam, San Jose, CA (US); Vikas Garg Kumar, Dhuri (IN); Sapan Kumar Behera, Hyderabad (IN); Anshul Sharma, Chicago, IL (US); Sathiyan Seran, Fremont, CA (US); Ritwik Reddy Nallavelly, Hyderabad (IN)

(21) Appl. No.: 17/829,792

(22) Filed: Jun. 1, 2022

Related U.S. Application Data
(60) Provisional application No. 63/243,403, filed on Sep. 13, 2021.

(51) Int. Cl. G06Q 10/06

(52) U.S. Cl. CPC G06Q 10/06316

(57) ABSTRACT

Request definitions associated with respective actions of a workflow identify characteristics of objects utilized in performance of the respective action. Hypothetical in-flight changes that modify the characteristics are anticipated and implemented into the workflow. The actions within the workflow are subscribed to the hypothetical in-flight changes based upon the characteristics identified in the request definitions and modified by the in-flight changes by identifying which in-flight changes affect which workflow actions. Accordingly, when an in-flight is received, the workflow is automatically updated to account for the modifications to the characteristics made by the in-flight change. Specifically, actions that should be undone and/or redone in response to the modification to the characteristics are automatically identified and new tasks are created to undo and/or redo the identified actions.

### CROSS-REFERENCE TO RELATED APPLICATION

This application claims priority to U.S. Provisional Patent Application No. 63/243,403, filed Sep. 13, 2021, and entitled, “SYSTEM AND METHOD FOR IMPLEMENTING IN-FLIGHT CHANGES TO A WORKFLOW,” which is incorporated by reference herein in its entirety for all purposes.

### BACKGROUND

The present disclosure relates generally to workflows and more specifically to adjusting workflows in response to in-flight changes received after a workflow has been initiated.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations. These resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able to redirect their resources to focus on their enterprise's core functions.

In modern communication networks, examples of cloud computing services a user may utilize include so-called infrastructure as a service (IaaS), software as a service (SaaS), and platform as a service (PaaS) technologies. IaaS is a model in which providers abstract away the complexity of hardware infrastructure and provide rapid, simplified provisioning of virtual servers and storage, giving enterprises access to computing capacity on demand. In such an approach, however, a user may be left to install and maintain platform components and applications. SaaS is a delivery model that provides software as a service rather than an end product. Instead of utilizing a local network or individual software installations, software is typically licensed on a subscription basis, hosted on a remote machine, and accessed by client customers as needed. For example, users are generally able to access a variety of enterprise and/or information technology (IT)-related software via a web browser. PaaS acts as an extension of SaaS that goes beyond providing software services by offering customizability and expandability features to meet a user's needs. For example, PaaS can provide a cloud-based developmental platform for users to develop, modify, and/or customize applications and/or automate enterprise operations without maintaining network infrastructure and/or allocating computing resources normally associated with these functions.

Organization may utilize cloud-based PaaS to implement workflows for providing products and/or services to customers, performing internal processes, or some other function. Typically, when a change (e.g., a change to a submitted order for products and/or services) is received after the workflow has been initiated, referred to as an “in-flight” change, the workflow is paused and a human administrator evaluates how the in-flight change affects the implementation of the workflow and what, if any, actions need to be undone and/or redone. For complex workflows and/or workflows for which multiple changes are submitted, such pauses can lead to extensive down time, wasted resources, and problems caused by human error.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The presently disclosed techniques relate to adjusting workflows in response to in-flight changes received after the workflow has been initiated. Specifically, request definitions associated with respective actions of a workflow identify characteristics utilized in performance of the respective action. Hypothetical in-flight changes that modify the characteristics are anticipated and implemented into the workflow. The actions within the workflow are subscribed to the hypothetical in-flight changes based upon the characteristics identified in the request definitions and modified by the in-flight changes by identifying which in-flight changes affect which workflow actions. Accordingly, when an in-flight is received, the workflow is automatically updated to account for the modifications to the characteristics made by the in-flight change. Specifically, actions that should be undone and/or redone in response to the modification to the characteristics are automatically identified and new tasks are created to undo and/or redo the identified actions. Such techniques allow for workflows to dynamically respond to in-flight changes, resulting in reduced downtime and less human error.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic diagram of an embodiment of the multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables the client instance, in accordance with aspects of the present disclosure;

FIG. 5 is an order fulfillment workflow, in accordance with aspects of the present disclosure;

FIG. 6 is an example of a particular order fulfillment workflow for an order for telecommunications products and/or services, in accordance with aspects of the present disclosure;

FIG. 7 illustrates a graphical user interface (GUI) for reviewing and approving the order of FIG. 6, in accordance with aspects of the present disclosure;

FIG. 8 illustrates a GUI that displays a list of tasks to be complete for fulfillment of the order shown in FIGS. 6 and 7, in accordance with aspects of the present disclosure;

FIG. 9 illustrates the GUI for reviewing and approving an order of FIG. 7 being used to revise the order, in accordance with aspects of the present disclosure;

FIG. 10 illustrates the GUI of FIG. 8, with states of the tasks in the list of tasks updated to “on hold” as the workflow is updated to accommodate an in-flight change, in accordance with aspects of the present disclosure;

FIG. 11 illustrates the GUI of FIGS. 8 and 10, with the states of the tasks in the list of tasks updated to accommodate the in-flight change, in accordance with aspects of the present disclosure;

FIG. 12 illustrates a GUI displaying a list of fulfillment policies associated with the workflow of FIG. 6, in accordance with aspects of the present disclosure;

FIG. 13 illustrates a GUI that displays a list of actions associated with the “SD-WAN Fulfillment Process” workflow of FIG. 12, in accordance with aspects of the present disclosure;

FIG. 14 illustrates the GUI of FIG. 13 with a create perform order validation task action expanded, in accordance with aspects of the present disclosure;

FIG. 15 illustrates a GUI for specifying a request definition for a task called “Allocate and Assign CPE”, in accordance with aspects of the present disclosure;

FIG. 16 illustrates a GUI seen by the user when performing the allocate and assign CPE task of FIG. 15, in accordance with aspects of the present disclosure;

FIG. 17 is a flowchart of a process for configuring a workflow to automatically adapt to in-flight changes in accordance with aspects of the present disclosure; and

FIG. 18 is a flow chart of a process for implementing an in-flight change, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

The presently disclosed techniques relate to adjusting workflows in response to in-flight changes received after the workflow has been initiated. Specifically, request definitions associated with respective tasks of a workflow identify characteristics utilized in performance of the respective task. Hypothetical in-flight changes that modify the characteristics identified by the request definitions are anticipated and implemented into the workflow. The tasks within the workflow are subscribed to the hypothetical in-flight changes based upon the characteristics identified in the request definitions and modified by the in-flight changes by identifying which in-flight changes affect what workflow tasks. Accordingly, when an in-flight change is received, the workflow is automatically updated to account for the modifications to the characteristics made by the in-flight change. Specifically, tasks that should be undone and/or redone in response to the modification to the characteristics are automatically identified and new tasks are created to undo and/or redo the identified tasks.

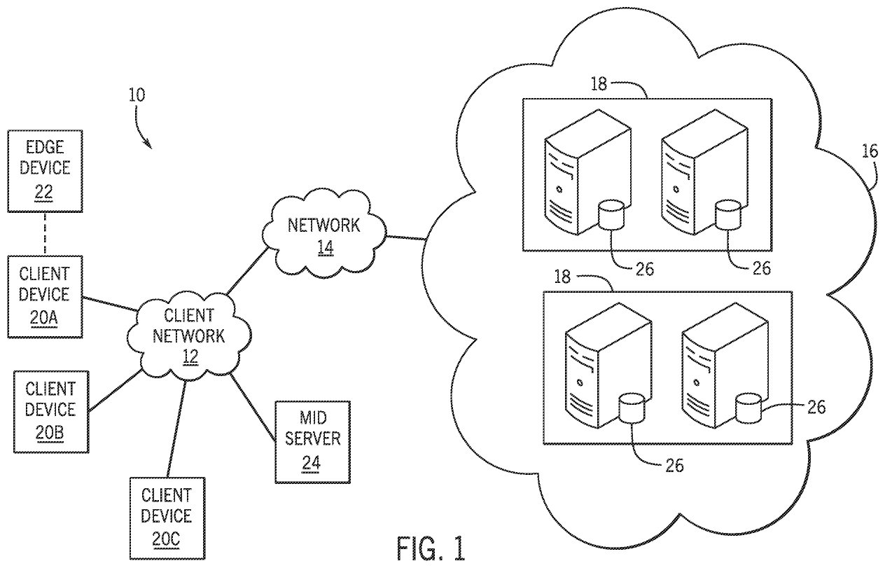

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to the figures, FIG. 1 illustrates a schematic diagram of an embodiment of a cloud computing system 10 where embodiments of the present disclosure may operate. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, agent, or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

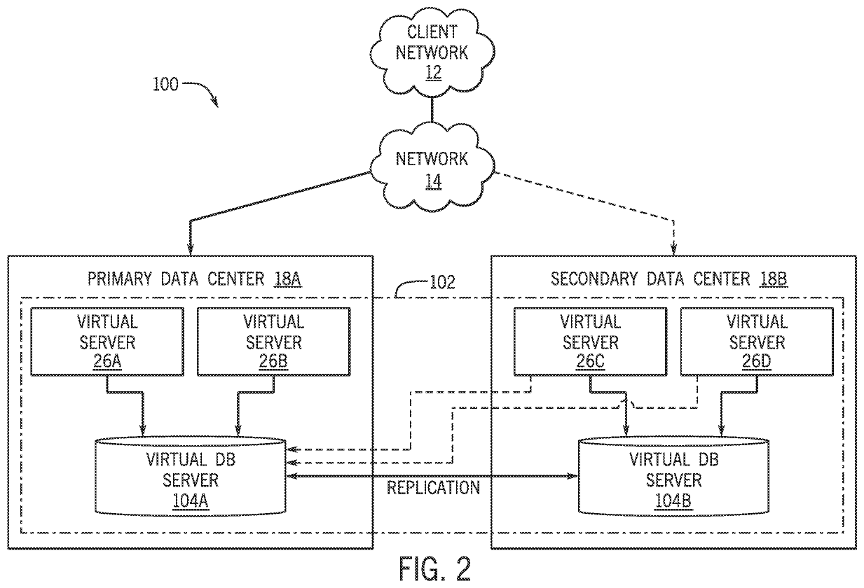

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

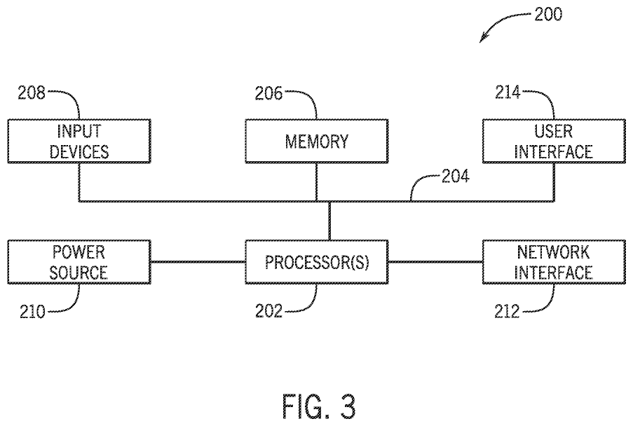

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

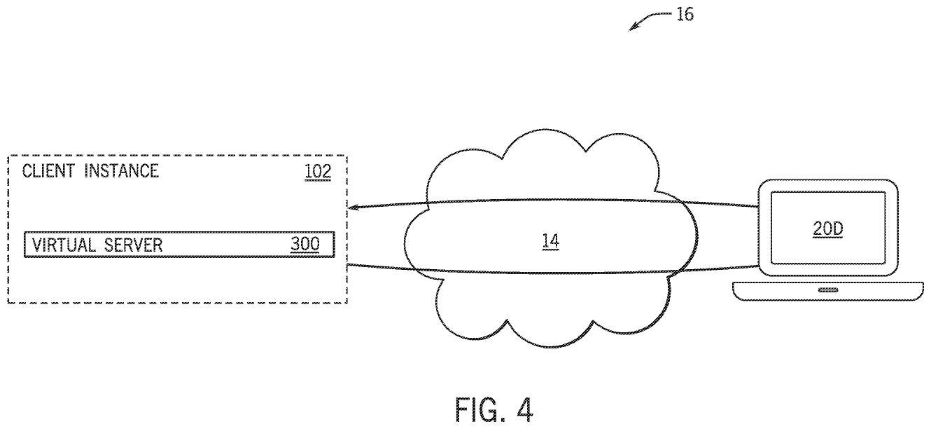

With the preceding in mind, FIG. 4 is a block diagram illustrating an embodiment in which a virtual server 300 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser running on the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

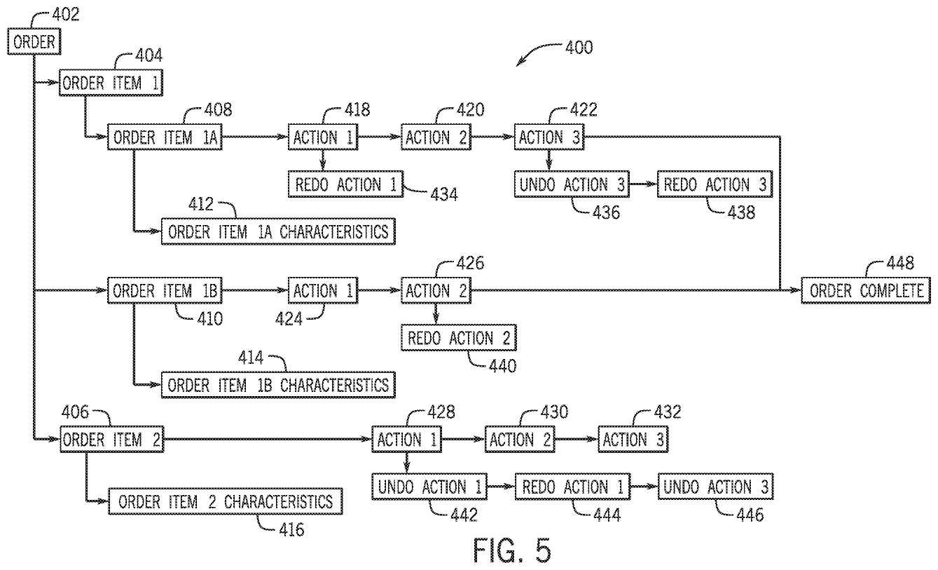

In some embodiments, customers may utilize the platform (e.g., via instances 102 and/or client devices) to facilitate performance of workflows. For example, the workflow may define processes for providing products and/or services to customers (e.g., fulfillment workflows), for performing internal functions, such as employee onboarding, off-boarding, and/or training, financial close, or performing some other function. FIG. 5 is an order fulfillment workflow 400 in accordance with an embodiment of the present disclosure. As shown, block 402 represents a received order that includes a hierarchy of items, in this case including two items (e.g., item1 and item2) represented by blocks 404 and 406. Further, item1 404 includes item1A (represented by block 408) and item1B (represented by block 410). In some embodiments, the order 402 may be for a telecommunication system (e.g., at a residence, an office, a retail location, an industrial facility, etc.). However, in other embodiments, the order 402 may be for information technology (IT) systems, consumer products, food, clothing, housewares, office supplies, toys, agricultural equipment, industrial equipment, software, vehicles, machinery, and so forth. Accordingly, fulfilment of the order 402 may involve procurement of one or more items 404, 406, 408, 410 within the order 402.

Each order item 406, 408, 410 at the lowest level of the hierarchy (e.g., the item 406, 408, 410 does not include any sub-items) is defined by respective item characteristics (e.g., item1A characteristics represented by block 412, item1B characteristics represented by block 414, and item2 characteristics represented by block 416). The respective item characteristics 412, 414, 416 may include data that describe and/or define the respective item. For example, the item characteristics 412, 414, 416 may include make/manufacturer, model number, serial number, size, color, memory size, firmware version, trim level, options, etc.

Each order item 406, 408, 410 at the lowest level of the hierarchy includes one or more workflow actions involved in procuring the item. For example, procurement of order item1A 408 includes action1, represented by block 418, action2, represented by block 420, and action3 represented by block 422. Similarly, procurement of order item1B 410 includes action1, represented by block 424, and action2, represented by block 426, and procurement of order item2 406 includes action1, represented by block 428, action2, represented by block 430, and action3, represented by block 432.

Once the order 402 has been placed, or the workflow 400 initiated, the entity that submitted the order 402 may wish to make a change to the order. For example, the entity may wish to add, remove, and/or change an item in the order, change a characteristic (e.g., quantity, model, size, color, option, etc.) of one or more of the items 404, 406, 408, 410, or otherwise make a change to the order 402. If the order 402 has been placed, and/or the workflow 400 has been initiated, such a change may be referred to as an “in-flight” change. Typically, when an in-flight change is received, the workflow 400 is paused and a human administrator manually determines how the in-flight change affects the workflow 400 and what actions need to be taken to adapt the workflow 400 to accommodate the in-flight change. For complex workflows 400 and/or workflows 400 that receive a large number of in-flight changes, such changes can significantly extend the amount of time it takes to complete the workflow 400 and lead to human errors that may result in the order 402 not being properly fulfilled and/or further extend the time for the order 402 to be properly fulfilled because of one or more corrections.

The present techniques allow for actions 418, 420, 422, 424, 426, 428, 430, 432 to be defined by request definitions that identify characteristics utilized in performance of the respective actions and subscribed to certain anticipated in-flight changes that affect the identified characteristics. Accordingly, the workflow anticipates possible in-flight changes such that when an in-flight change is received, the workflow 400 reduces downtime by automatically adjusting to the in-flight change and continuing the workflow 400. For example, as shown in FIG. 5, receiving an in-flight change may cause the workflow to proceed to block 434 in which Action1 418 is redone. In some embodiments, an in-flight change may cause certain actions to merely be redone. However, in other embodiments, the in-flight change may cause certain actions to be undone and then redone. For example, if an action includes ordering components from a supplier, rather than submitting a new order for different components in response to an in-flight change, when the in-flight change is received, the workflow 400 may cancel a previously submitted order for components and submit a new order for different components. Accordingly, as shown in FIG. 5, receiving an in-flight change may cause the workflow 400 to implement block 436 and undo Action3, and then proceed to block 438 and redo Action3 based on the in-flight change. Along these lines, Action2, associated with OrderItem1B 410 may be subscribed to an in-flight change such that when the in-flight change is received, the workflow 400 proceeds to block 440 and redoes Action2 236. Similarly, Action1 428 and Action3 432, associated with OrderItem2 406 may be subscribed to one or more in-flight changes such that when the in-flight changes are received, the workflow 400 moves to block 442 and undoes Action1 428, then proceeds to block 444 and redoes Action1 428. The workflow 400, in series or in parallel, may also proceed to block 446 and redo Action3 432.

Subscribing an action to an in-flight change may include, for example, writing to memory a relationship or a mapping that relates the action (or the request definitions associated with the action) to the in-flight change. In some embodiments, a table (e.g., of a database) may include records that represent relationships between actions (or request definitions associated with actions) and in-flight changes, as well as the characteristics shared by the actions and the in-flight changes.

The process proceeds along the workflow 400, responding to in-flight changes, if any, as they are received, until the process reaches the final block 448, indicating that the order is complete. It should be understood that the workflow 400 shown in FIG. 5 is merely an example and that many other embodiments of workflows are envisaged. For example, though the workflow 400 shown in FIG. 5 is for a process of fulfilling an order, it should be understood that the disclosed techniques may be used for any workflow that receives in-flight changes once the workflow is initiated.

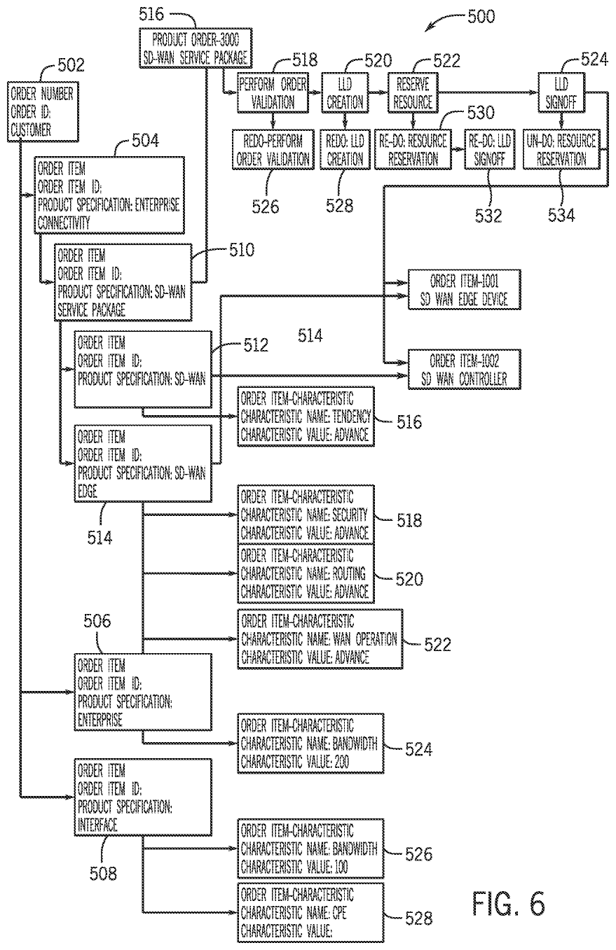

FIG. 6 is an example of a specific order fulfillment workflow 500 for an order for telecommunications products and/or services in accordance with an embodiment. As shown, an order 502 includes items 504, 506, 508. Item 504 includes sub-item 510, which further includes sub-sub-items 512, 514. The lowest items in the hierarchy (e.g., the items or sub-items that do not contain respective sub-items) each have one or more associated sets of characteristics 516, 518, 520, 522, 524, 526, 528. As shown, the workflow 500 includes actions associated with items in the order 502 that may be performed in procuring the items and completing the order 502. For example, a product order block 516 is associated with sub-item 510. The workflow 500 proceeds through an order validation block 518, a low-level design (LLD) creation block 520, a reserve resource block 522, and a LLD signoff block 524. As described with regard to FIG. 5, some of the actions may be subscribed to anticipated in-flight changes such that when an in-flight change is received, the workflow 500 proceeds to progress through one or more blocks associated with the in-flight change to undo and/or redo some of the actions within the workflow 500. For example, as shown in FIG. 6, some in-flight changes may cause the workflow 500 to progress to block 526 and redo order validation. Similarly, some in-flight changes may cause the workflow 500 to progress to block 528 and redo LLD creation. Other in-flight changes may cause the workflow 500 to progress to block 530 and undo a resource reservation and then proceed to block 532 and redo the resource reservation for the updated resource. Some in-flight changes may cause the workflow 500 to progress to block 534 and redo LLD signoff.

As shown in FIG. 6, the other items in the order 502 may have other actions to be performed as the procurement workflow 500 progresses to completion. As previously discussed, it should be understood that, though the workflow 500 shown in FIG. 6 is for fulfillment of a telecommunications order, the disclosed techniques may be utilized in the performance of any workflow that may receive in-flight changes once the workflow is in progress. Accordingly, the claims are not intended to me limited to the specific embodiments disclosed herein.

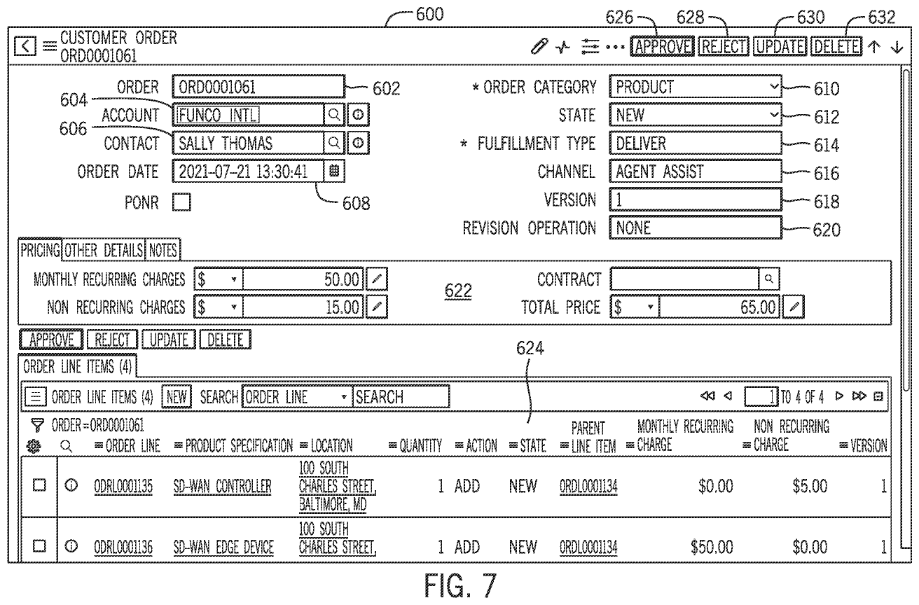

FIG. 7 illustrates a graphical user interface (GUI) 600 for reviewing and approving an order, in accordance with aspects of the present disclosure. As shown, the GUI 600 includes fields for order identification 602, the account submitting the order 604, the contact for the order 606, the order date 608, the order category 610 (e.g., product, service, mixed, etc.), the state of the order 612 (e.g., new, revised/updated, fulfilled, closed, etc.), the fulfillment type 614 (e.g., pickup, ship, deliver), the channel of the order 616 (e.g., agent assist, automated, self-serve, etc.), the order version 618, and the revision operation 620. An order information window 622 selectively displays, based upon which tab is selected from a row of tabs, pricing for the order, other details about the order, and/or notes created for the order. A line item window 624 displays a list of items in the order, along with information about each item (e.g., order line, product specification, location, quantity in order, action, state, parent line item, if any, monthly recurring charges, non-recurring charges, version, etc.). In the present embodiment, the items in the line item window 624 correspond to the items in the order shown in FIG. 6. However, it should be understood that similar GUIs 600 could be generated for other types of orders having different items. The GUI 600 has a toolbar that includes selectable buttons for approving the order 626, rejecting the order 628, updating the order 630, and deleting the order 632, which the reviewer may use to respectively approve, reject, update, and delete the order. When the approve button 626 is selected via the GUI 600, the fulfillment workflow for the order is initiated, generating tasks to be completed to fulfill the order.

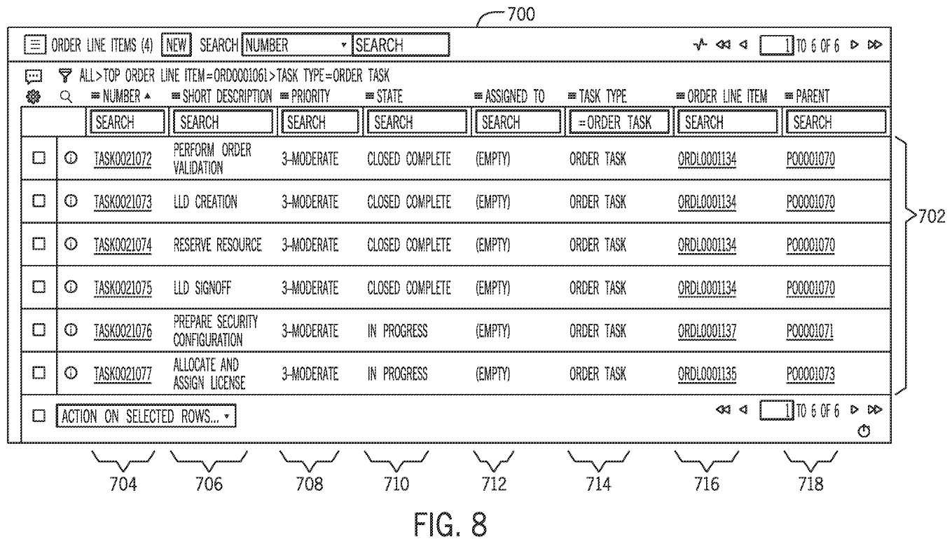

FIG. 8 is a GUI 700 that displays a list of tasks 702 to be completed for fulfillment of the order shown in FIGS. 6 and 7. The tasks 702 shown in FIG. 8 correspond to the actions shown in the workflow 500 of FIG. 6. Each task in the list of tasks 702 includes fields of task number 704, task description 706, task priority 708, task state 710, person/entity to which the task is assigned 712, task type 714, order line item 716, and parent task 718. As shown, the task state field 710 for each task indicates whether the task has been completed, is in progress, is on hold, or scheduled. New tasks may be added to the list of tasks 702 as the workflow progresses and tasks/actions are completed. Similarly, when an in-flight change is received, the task state fields 710 may be updated to reflect adjustments to the workflow based on the in-flight change. For example, when an in-flight change is received, certain tasks may be put on hold while previously completed tasks are undone and/or redone.

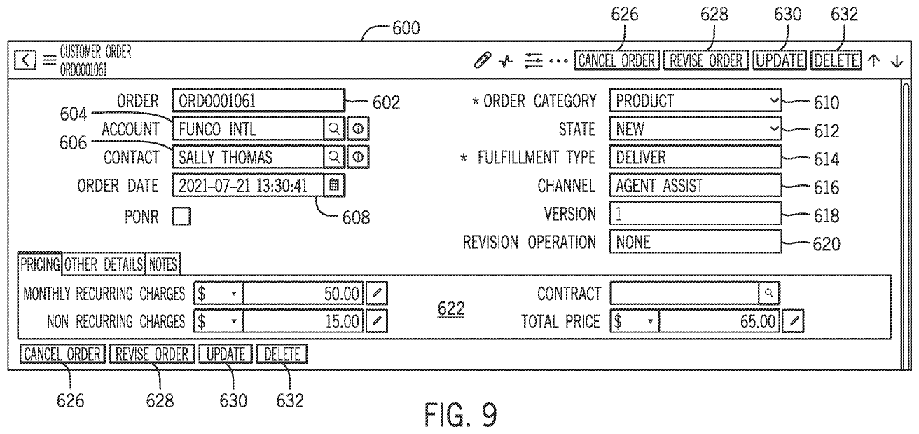

FIG. 9 illustrates the GUI 600 for reviewing and approving an order of FIG. 7 being used to revise a submitted order, in accordance with aspects of the present disclosure. As shown, the state of the order field 612 has been updated to indicate that the order is in progress. The user may make adjustments to the order (e.g., quantity, price, order contact, fulfillment type, etc.) and then select the revise order button 628 to revise the order and create an in-flight change. Once the in-flight change is received, the characteristics affected by the in-flight change are used to adjust the workflow (e.g., identify which actions are to be undone and/or redone based on characteristics identified by request definitions associated with the actions) to accommodate the in-flight change. As previously described, the various actions within the workflow are subscribed to various possible anticipated or hypothetical in-flight changes, such that when an in-flight change is received, actions that are to be undone and/or redone can be quickly identified, existing tasks put on hold, and new tasks created to undo and/or redo actions are to be undone and/or redone.

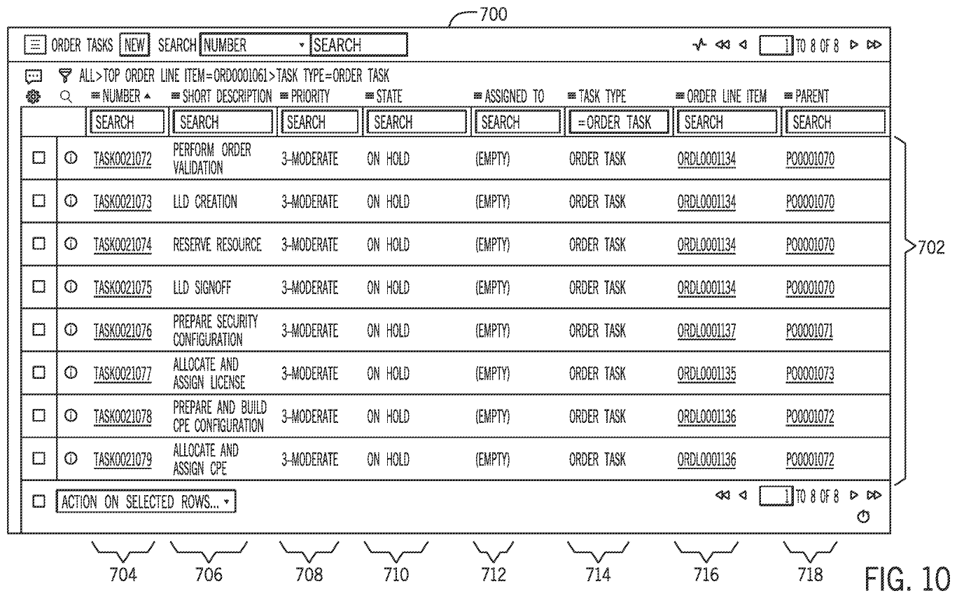

FIG. 10 illustrates the GUI 700 of FIG. 8, but with the states 710 of the tasks in the list of tasks 702 updated to “on hold” as the workflow is updated to accommodate the in-flight change. For example, new tasks may be created for undoing and/or redoing completed actions based on the in-flight change.

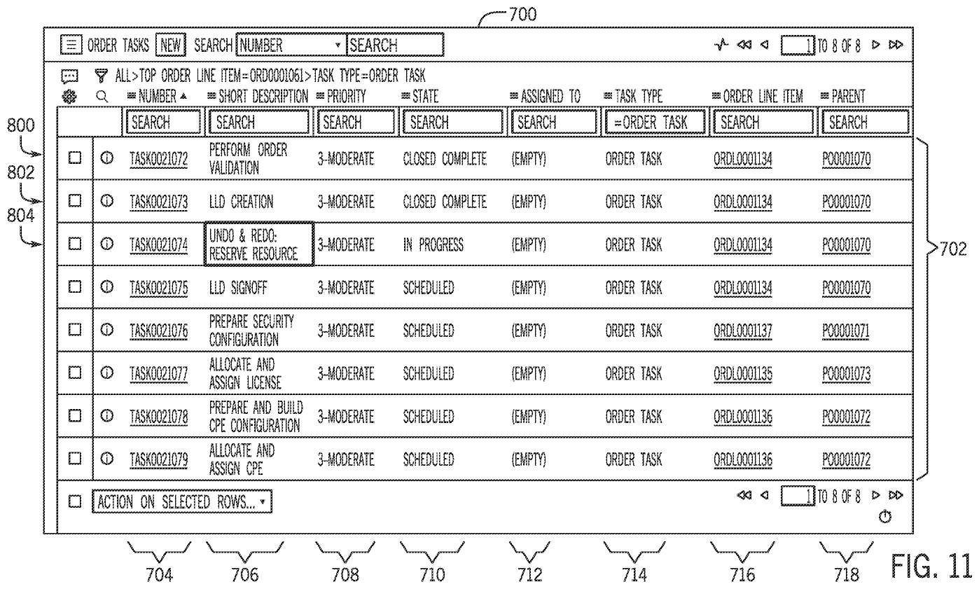

FIG. 11 illustrates the GUI 700 of FIGS. 8 and 10, but with the states 710 of the tasks in the list of tasks 702 updated to accommodate the in-flight change. As shown, task 800 has been added to redo order validation, task 802 has been added to redo LLD creation, and task 804 has been added to undo and redo reserving resources. As shown, some tasks in the list of tasks 702 are shown as “scheduled” and are contingent upon other tasks being completed.

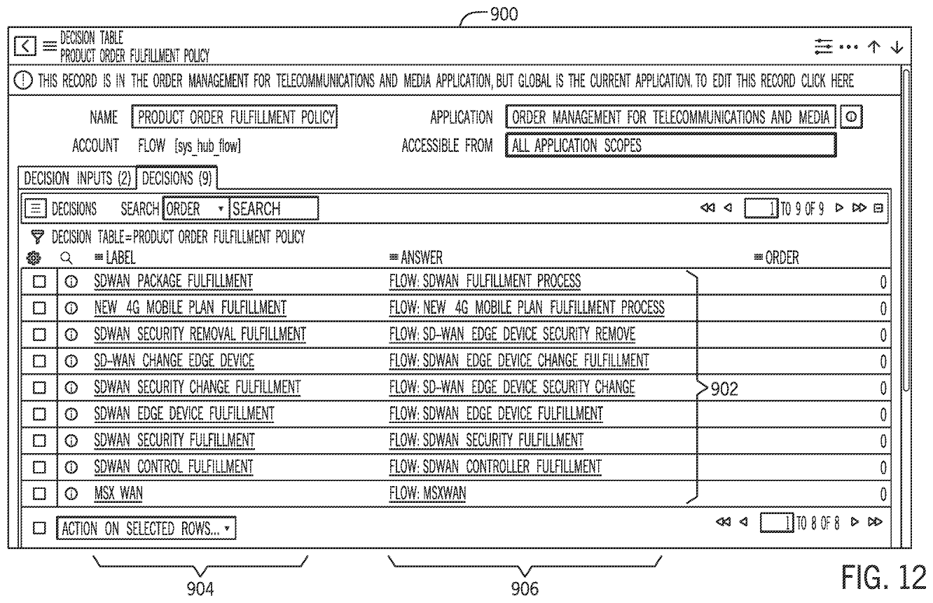

Workflows being quickly updated in response to in-flight changes is made possible via fulfillment policies that may be included in the platform with little or no setup performed by the customer. FIG. 12 is a GUI displaying a list of fulfillment policies 902 included in a particular embodiment of the platform. As shown, each policy includes a label 904 identifying a particular product, service, groups of products and/or services, actions, in-flight changes, etc. and a corresponding workflow 906 associated with fulfilling the products/services, and/or implementing the change. Accordingly, workflows 906 associated with various relevant policies 902 may be pulled and combined to create a larger workflow for fulfilling an order. Selection of a particular workflow 906 within the GUI may cause a new GUI to be displayed that lists the actions included in the selected workflow.

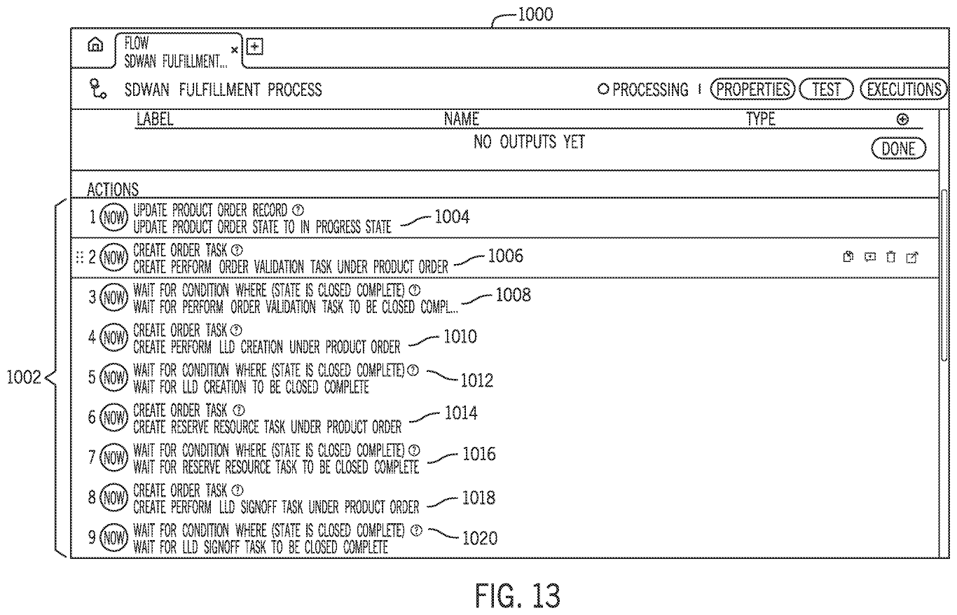

FIG. 13 is a GUI 1000 that displays a list of actions 1002 associated with the “SD-WAN Fulfillment Process” workflow shown in FIG. 12. It should be noted that the list of actions 1002 shown in FIG. 13 match the actions in the workflow 500 of FIG. 6 associated with the SD-WAN item 510, but are shown as a list rather than in a flow chart. As shown, action 1004 includes updating a corresponding product order record such that the product order state is “in progress”. Action 1006 includes creating an order task for performing order validation. When such a task is created, it would be displayed in the list of tasks within the GUI 700 of FIGS. 8 and 10. Action 1008 includes waiting until the perform order validation task has been completed to proceed. Action 1010 includes creating an order task for performing LLD creation. Action 1012 includes waiting until the performing LLD creation task has been completed to proceed. Action 1014 includes creating an order task for reserving resources. Action 1016 includes waiting until the reserving resources task has been completed to proceed. Action 1018 includes creating an order task for performing LLD signoff. Action 1020 includes waiting until the LLD signoff task has been completed to proceed.

As previously described, the actions shown in FIG. 13 are actions for a single item in the order shown in FIG. 6. As such, it should be understood that fulfilling the order shown in FIG. 6 may involve combining multiple workflows associated with different products/services into a larger fulfillment workflow. The larger fulfillment workflow may include multiple workflows that are performed or otherwise carried out in parallel and/or in series.

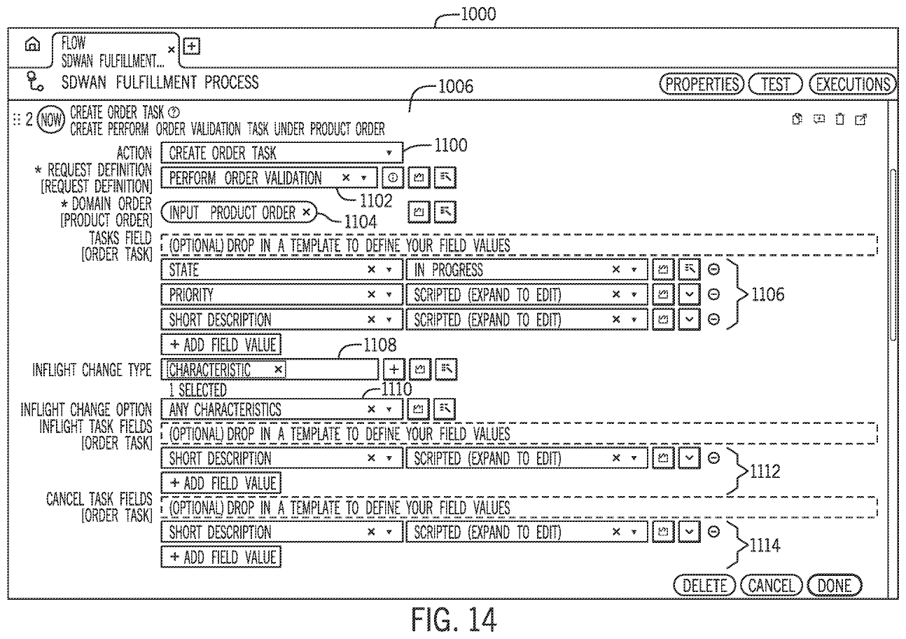

From the GUI 1000 a user may select a particular action from the list of actions 1002. The selected action expands, allowing the user to customize and/or edit the action. FIG. 14 shows the GUI 1000 of FIG. 13 with the create perform order validation task action expanded. As shown, the GUI 1000 includes a number of data fields that can be filled in to define the corresponding action 1006. Specifically, the action field 1100 specifies the action to be taken. In the present embodiment, the action is creating an order task to be performed. However, other actions may include updating records, waiting until other actions are performed, some triggering event occurs, or some condition is true, and so forth. The request definition field 1102 identifies a task associated with the action. The domain order field 1104 identifies a domain and/or a domain hierarchy associated with the order. The task fields 1106 include one or more user-specified fields associated with the task. For example, in the embodiment shown in FIG. 14, the task field includes a task state, a task priority, and a short description of the task. As shown, the fields may be selected from a drop-down menu. Once a field has been selected, the user may select a value for the field, either via drop down menu, by providing a character string, or by identifying a script to be executed. As shown, the user may add or remove task fields from the list of task fields 1106 as desired.

The in-flight change type field 1108 specifies the type of in-flight change to which the action is subscribed. In the present embodiment, the action is subscribed to an in-flight change of a characteristic. However, the action may be subscribed to in-flight changes of any type that may affect the order (e.g., price, contact, account, quantity, order category, fulfillment type, delivery location, and so forth). The in-flight change option field 1110 indicates that the action is subscribed to in-flight changes to any characteristic. For example, an in-flight change to any characteristic may cause a task to be created that a reviewer reviews the updated order, regardless of which characteristics were changed. In some embodiments, the action may be subscribed only to in-flight changes to characteristics identified in the request definition for the action. For example, the in-flight change option field 1110 may identify specific characteristics, wherein the action is only subscribed to in-flight changes to the specifically identified characteristics, rather changes to any characteristic. The in-flight task fields 1112 identify one or more fields of the associated task that may be affected by the in-flight change. Similarly, the cancel task fields 1112 identify one or more fields of the associated task that may be affected by a decision to cancel the order or a particular task associated with the order. As shown, in some embodiments, users may specify one or more fields of the GUI 1000 manually or via a script. In other embodiments, a user may utilize a template to specify one or more fields within the GUI 1000 and then manually adjust the fields as desired.

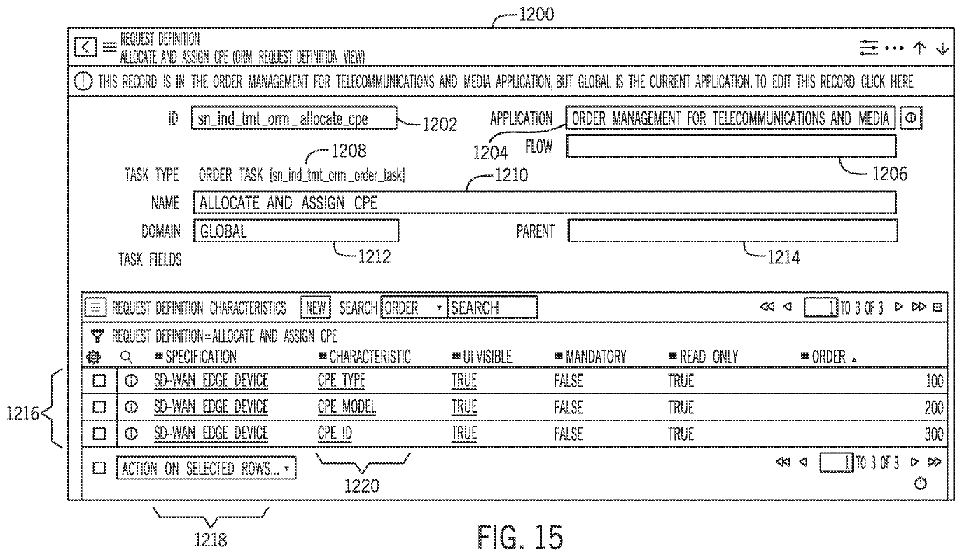

FIG. 15 is a GUI 1200 for specifying a request definition for a task called “Allocate and Assign CPE”. The Allocate and Assign CPE task occurs in the provisioning of a SD-WAN Edge Device included in an order. As shown, the GUI includes a number of fields that define the request definition. The request definition ID field 1202 includes a character string that identifies the request definition and/or or associated action. The application field 1204 identifies the application that facilitates the task or action being performed, in this case Order Management for Telecommunications and Media. The flow field 1206 identifies the flow in which the task is performed. The task type field 1208 identifies the task type for the task associated with the request definition. In the present embodiment, the task type is an order task. The name field 1210 identifies the name of the request definition and/or the associated task. The domain field 1212 identifies the domain in which the task is performed. The parent field 1214 identifies one or more parent tasks and/or request definitions, if any.

As shown, the GUI 1200 includes a list of items 1216 that are affected by the associated task being performed. For each item, the GUI 1200 includes a specification 1218 that identifies a particular item and/or service and a characteristic 1220 of that item and/or service 1220 that is affected by the task being performed. For example, in the instant embodiment, the associated task involves allocating and assigning customer premises equipment (CPE) for a received telecommunications order. Specifically, the task includes allocating and assigning a SD-WAN edge device for a telecommunications order. In performing the task, a user identifies one or more types of CPE that have been allocated to the customer, the specific model numbers of the CPE that have been allocated to the customer, and the CPE identification numbers for the CPE that have been allocated to the customer. As such, when the associated task is being performed, the characteristics are displayed on a GUI for the user to specify or fill in. As shown, some characteristics may be specified as mandatory (e.g., the task is not completed until the characteristics have been provided), while other characteristics are not mandatory (e.g., the task can be completed without certain characteristics being provided). Accordingly, the CPE type, CPE model, and CPE id are shown as characteristics of the request definition and the associated action.

Once filled in, the request definition may be saved in memory as a data structure, or as a record in a table or database, that relates a task to one or more objects (e.g., items, services, etc.) involves in performing the task. Specifically, the request definition may identify characteristics of an object that are provided, modified, confirmed, or otherwise utilized during performance of the task. The request definition allows for ordered tasks to be uniquely defined and identified as a particular type of task. Previously, creating a new type of task would involve creating a new table that acts as an extension of an existing task table. However, the request definition allows for multiple unique task types to be created in a single task table (e.g., an “order task table”). Within the single task table, tasks may be identified via a unique name or identification string. The unique task name/id may then be used in workflows to identify and dynamically interact with unique tasks within a larger task object.

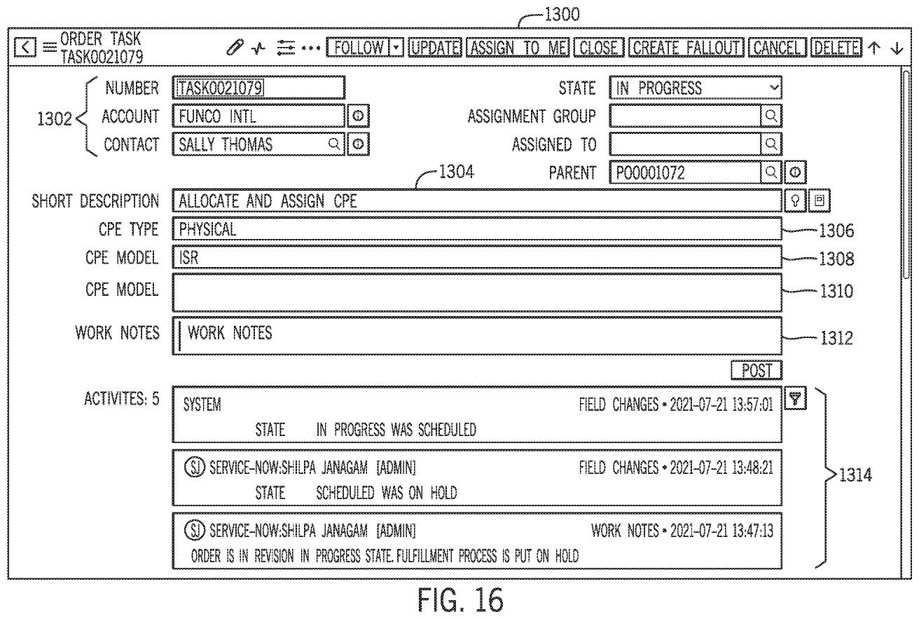

FIG. 16 illustrates the GUI 1300 seen by the user when performing the allocate and assign CPE task. The GUI includes a number of data fields 1302 that provide basic information about the task and/or the associated order. For example, the data fields may identify the task number, the account for the order, the contact for the order, the state of the order or task, the assignment group, the person or team to which the task is assigned, a parent task, and so forth. The GUI 1300 also includes a short description field 1304 that provides a short description for the task (e.g., “allocate and assign CPE”). The GUI 1300 displays fields for the characteristics that are associated with the task (e.g., performance of a workflow action). For example, in the illustrated embodiment, the GUI 1300 displays a CPE type field 1306, a CPE model field 1308, and a CPE id field 1310 by which the user provides information about the CPE allocated to the customer. Note that these data fields correspond to the characteristics of the request definition shown in FIG. 15. The GUI 1300 also includes a work notes field 1312 by which the user provides any notes that may be relevant to the task or underlying order, and a listing of activities associated with the task and/or the underlying order. In some embodiments, the activities may correspond to other actions in the workflow.

If an in-flight change is received after the CPE have been allocated to the customer (i.e., the allocate and assign CPE task has been completed), and the in-flight change includes a change to any of the identified characteristics (e.g., CPE type, CPE model, and CPE id), the allocated and assign CPE task may need to be undone and/or redone. As such, the request definition and/or the associated action are said to be subscribed to in-flight changes that affect CPE type, CPE model, and CPE id. Such an arrangement allows the underlying workflow to adjust to in-flight changes quickly without having to pause the workflow while a human determines what steps of the workflow are to be undone and/or redone.

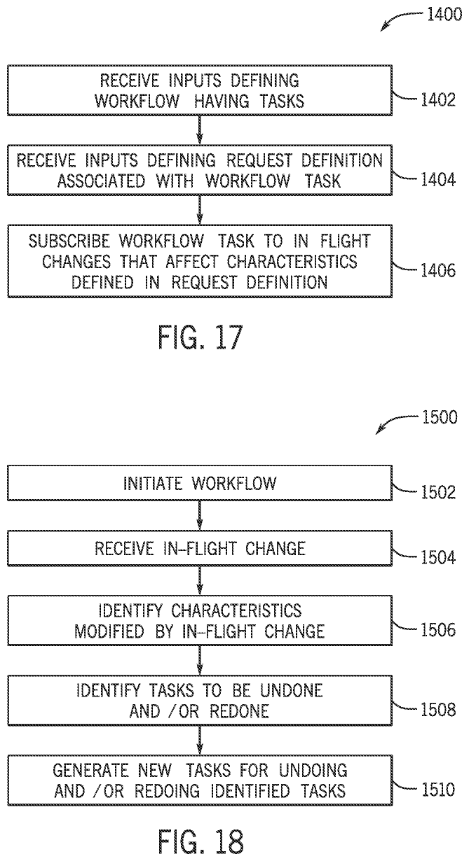

FIG. 17 is a flowchart of a process 1400 for configuring a workflow to automatically adapt to in-flight changes. At block 1402, inputs are received that define a workflow having two or more tasks or actions. The workflow may be for fulfilling an order, providing services to a customer, performing a function within an organization, or any other series of multiple actions. At block 1404, inputs are received that define a request definition for an action or task of the workflow. As previously described, the request definition may identify one or more characteristics that are defined, specified, or otherwise utilized during performance of the associated action. As previously discussed, the request definition may be saved in memory as a data structure, or as a record in a table or database, that relates a task to one or more objects (e.g., items, services, etc.) involves in performing the task. Specifically, the request definition may identify characteristics of an object that are provided, modified, confirmed, or otherwise utilized during performance of the task. At block 1406, the workflow action or task associated with the request definition is subscribed to in-flight changes that affect the characteristics defined in the request definition associated with the action. Subscribing the request definition to the in-flight changes that affect the characteristics defined in the request definition associated with the action may include, for example, writing to memory a relationship or a mapping that relates the action (or the request definitions associated with the action) to the in-flight change. In some embodiments, a table (e.g., of a database) may include records that represent relationships between actions (or request definitions associated with actions) and in-flight changes, as well as the characteristics shared by the actions and the in-flight changes. Accordingly, when an in-flight change is received that affects the characteristics defined in the request definition associated with the action, the workflow may be automatically updated, creating one or more new tasks to undo and/or redo the associated action based on the updated characteristics as a result of the in-flight change.

FIG. 18 is a flow chart of a process 1500 for implementing an in-flight change. At block 1502 a workflow is initiated. As previously described, the workflow may be for fulfilling an order, providing services to a customer, performing a function within an organization, or any other series of multiple actions or tasks. The workflow may be initiated in response to receiving an order, receiving a request, receiving input from a user, the occurrence of some triggering event of condition, or some other reason. At block 1504, an in-flight change is received. At block 1506, characteristics modified by the in-flight change are identified. As previously described, the in-flight change may modify any aspect of an order and/or the workflow, such as a quantity, price, model, service provider, order contact, location, contact information, and so forth. At block 1508, actions and/or tasks to be undone and/or redone are identified. In some embodiments, identifying actions to be undone and/or redone may be a matter of identifying actions that are subscribed to the in-flight change and have already been completed, and then adjusting performance of the workflow accordingly. As previously described, actions may be associated with respective request definitions that identify one or more characteristics that are defined, provided, or otherwise utilized during performance of the action. Accordingly, am action and/or the corresponding request definition may be subscribed to in-flight changes that affect the characteristics identified in the request definition. Such in-flight changes may be anticipated and incorporated into the workflow in advance such that when an in-flight change is received, the workflow automatically adjusts to the change. Accordingly, in block 1510 new tasks are generated for undoing and/or redoing the identified actions.

The presently disclosed techniques relate to adjusting workflows in response to in-flight changes received after the workflow has been initiated. Specifically, request definitions associated with respective actions of a workflow identify characteristics utilized in performance of the respective action. Hypothetical in-flight changes that modify the characteristics are anticipated and implemented into the workflow. The actions within the workflow are subscribed to the hypothetical in-flight changes based upon the characteristics identified in the request definitions and modified by the in-flight changes by identifying which in-flight changes affect which workflow actions. Accordingly, when an in-flight is received, the workflow is automatically updated to account for the modifications to the characteristics made by the in-flight change. Specifically, actions that should be undone and/or redone in response to the modification to the characteristics are automatically identified and new tasks are created to undo and/or redo the identified actions. Such techniques allow for workflows to dynamically respond to in-flight changes, resulting in reduced downtime and less human error.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a processor; and
a memory, accessible by the processor, and storing instructions that, when executed by the processor, cause the processor to perform operations comprising:
initiating a workflow comprising a first task, wherein the first task is associated with a request definition that identifies one or more characteristics of an object utilized during performance of the first task;
receiving an indication that the first task has been completed;
receiving an in-flight change that modifies the one or more characteristics; and
generating a second task to re-perform the first task based on the modification to the one or more characteristics specified by the in-flight change.

2. The system of claim 1, wherein the operations comprise generating a third task to undo the first task.

3. The system of claim 2, wherein the operations comprise putting a fourth task on hold until the second task is completed.

4. The system of claim 1, wherein the operations comprise identifying which of a plurality of tasks of the workflow are subscribed to the in-flight change.

5. The system of claim 4, wherein identifying which of the plurality of tasks of the workflow are subscribed to the in-flight change comprises identifying one or more tasks of the plurality of tasks having respective request definitions that identify the one or more characteristics.

6. The system of claim 1, wherein the workflow is initiated in response to receiving an order.

7. The system of claim 1, wherein the workflow is for fulfilment of an order for products, services, or a combination thereof.

8. A method, comprising:
receiving an input defining a request definition associated with a first task of a workflow, wherein the request definition identifies one or more characteristics of an object utilized during performance of the first task;
identifying an in-flight change that modifies the one or more characteristics; and
writing to a memory a relationship subscribing the first task to the in-flight change such that when the in-flight change is implemented after performance of the first task, a second task is generated to re-perform the first task based on the one or more characteristics as modified by the in-flight change.

9. The method of claim 8, comprising receiving an order, and initiating the workflow to fulfill the order.

10. The method of claim 9, comprising:
receiving an indication that the first task has been completed; and
receiving the in-flight change.

11. The method of claim 10, comprising generating the second task to re-perform the first task in response to the in-flight change being received and the first task being subscribed to the in-flight change.

12. The method of claim 11, comprising generating a third task to undo the first task.

13. The method of claim 12, comprising putting a fourth task on hold until the second task is completed.

14. The method of claim 9, wherein the order is for products, services, or a combination thereof.

15. A non-transitory computer readable medium comprising instructions that, when executed by a processor, cause the processor to perform operations comprising:
initiating a workflow comprising a plurality of tasks;
receiving an in-flight change that modifies one or more first characteristics associated with the workflow;
identifying a first completed task of the plurality of tasks, wherein the first completed task is associated with a first request definition that identifies the one or more first characteristics as utilized during performance of the first completed task; and
generating a second task to re-perform the first completed task based on the one or more first characteristics as modified by the in-flight change.

16. The computer readable medium of claim 15, wherein the operations comprise generating a third task to undo the first completed task.

17. The computer readable medium of claim 16, wherein the operations comprise putting a fourth task on hold until the second task is completed.

18. The computer readable medium of claim 15, wherein the operations comprise identifying which of the plurality of tasks of the workflow are subscribed to the in-flight change, comprising identifying one or more tasks of the plurality of tasks having respective request definitions that identify the one or more first characteristics.

19. The computer readable medium of claim 15, wherein the workflow is initiated in response to receiving an order.

20. The computer readable medium of claim 19, wherein the order is for products, services, or a combination thereof.
